(19) United States
(12) Patent Application Publication
(10) Pub. No.: US 2019/0200130 A1
(43) Pub. Date: Jun. 27, 2019

(54) SILENT DISCO ROLLER SKATING

(71) Applicant: Dellisa Nayshelle Richardson, Westville, NJ (US)

(72) Inventor: Dellisa Nayshelle Richardson, Westville, NJ (US)

(21) Appl. No.: 16/233,055

(22) Filed: Dec. 26, 2018

Related U.S. Application Data
(60) Provisional application No. 62/609,882, filed on Dec. 22, 2017.

(51) Int. Cl. H04R 3/12; E04H 3/14; G06Q 30/06; H04R 1/10

(52) U.S. Cl. CPC H04R 3/12; E04H 3/14; H04R 2420/03; H04R 1/1091; H04R 2420/07; G06Q 30/0645

(57) ABSTRACT

A system and method for hosting a silent roller skating event. The system includes a first station that includes roller skates and a first group of headphones for users to rent. The system includes a second station that includes a second group of headphones for users to rent, but does not include roller skates. The system includes a music station that includes first, second and third substations in operative association with each headphone. Each headphone has first, second, and third channels and a channel selector switch. The first substation is configured to transmit a first type of music to the first channel of each headphone. The second substation is configured to transmit a second type of music to the second channel of each headphone. The third substation is configured to transmit a third type of music to the third channel of each headphone. Each headphone outputs the first type of music from the first substation in response to the channel selector switch being in a first position. Each headphone outputs the second type of music from the second substation in response to the channel selector switch being placed in a second position. Each headphone outputs the third type of music from the third substation in response to the channel selector switch being placed in a third position.

### CROSS-REFERENCE TO RELATED APPLICATIONS

This application claims benefit under 35 U.S.C. § 119(e) of Provisional Application No. 62/609,882 filed Dec. 22, 2017, the disclosure of which is incorporated by reference in its entirety.

### FIELD

This application relates generally to a roller skating activity. More specifically, the present invention is a system and method for hosting a silent roller skating event.

### BACKGROUND

Roller skating rinks generally have music played through speakers. Some rinks may have a disc jockey that plays certain types of music. Some roller skaters and other persons in the rink like the music to be at a high volume. However, other person do not like the music at high volume. For example, a person may want to communicate with another person without the music interfering with their conversation. Further, neighbors next to the rink may not want to hear the loud music coming from the rink. Also, other persons may not want to hear the type of music that is being played.

Roller skating rink systems and methods for hosting roller skating events may benefit from improvements.

### SUMMARY

In one aspect of the present invention, a system for hosting a silent roller skating event is provided. The system includes a first station that includes roller skates and a first group of headphones for users to rent. The system includes a second station that includes a second group of headphones for users to rent, but does not include roller skates. The system includes a music station that includes first, second and third substations in operative association with each headphone. Each headphone has first, second, and third channels and a channel selector switch. The first substation is configured to transmit a first type of music to the first channel of each headphone. The second substation is configured to transmit a second type of music to the second channel of each headphone. The third substation is configured to transmit a third type of music to the third channel of each headphone. Each headphone outputs the first type of music from the first substation in response to the channel selector switch being in a first position. Each headphone outputs the second type of music from the second substation in response to the channel selector switch being placed in a second position. Each headphone outputs the third type of music from the third substation in response to the channel selector switch being placed in a third position.

In another aspect of the present invention, a method of hosting an event at a roller skating rink is provided. The method includes a) admitting users into the roller skating rink at a roller skating admission station; b) providing roller skates and headphones to users who desire to rent roller skates and headphones at a first station; c) providing headphones to users at a second station that does not provide roller skates; d) transmitting music of a first type from a first substation of a music station to a first channel of each headphone; f) transmitting music of a second type from a second substation of the music station to a second channel of each headphone; g) transmitting music of a third type from a third substation of the music station to a third channel of each headphone; and h) enabling the headphone to allow selection of one of the first channel, second channel, and third channel to output music from the selected channel.

Other aspects of the disclosed invention will become apparent from the following detailed description, the accompanying drawings and the appended claims.

### BRIEF DESCRIPTION OF THE DRAWINGS

FIG. 1 is schematic diagram of the roller skating rink system according to an embodiment of the present invention;

FIG. 2 is a block diagram of a portion of the roller skating rink system of FIG. 1;

FIG. 3 is a perspective view of wireless headphone of the roller skating rink system of FIG. 1;

FIG. 4 is a side view of a pair of roller skates of the roller skating rink system of FIG. 1;

FIG. 5A is a schematic side view of a portion of the wireless headphone of FIG. 3 illustrating the first LED illuminating and the channel selector switch in the first position with portions of the LED lined with blue;

FIG. 5B is a schematic side view of a portion of the wireless headphone of FIG. 3 illustrating the second LED illuminating and the channel selector switch in the second position with portions of the LED lined with red;

FIG. 5C is a schematic side view of a portion of the wireless headphone of FIG. 3 illustrating the third LED illuminating and the channel selector switch in the third position with portions of the LED lines with green; and

FIG. 6 is a flow diagram of a method of hosting an event at a roller skating rink using the roller skating rink system of the present invention.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

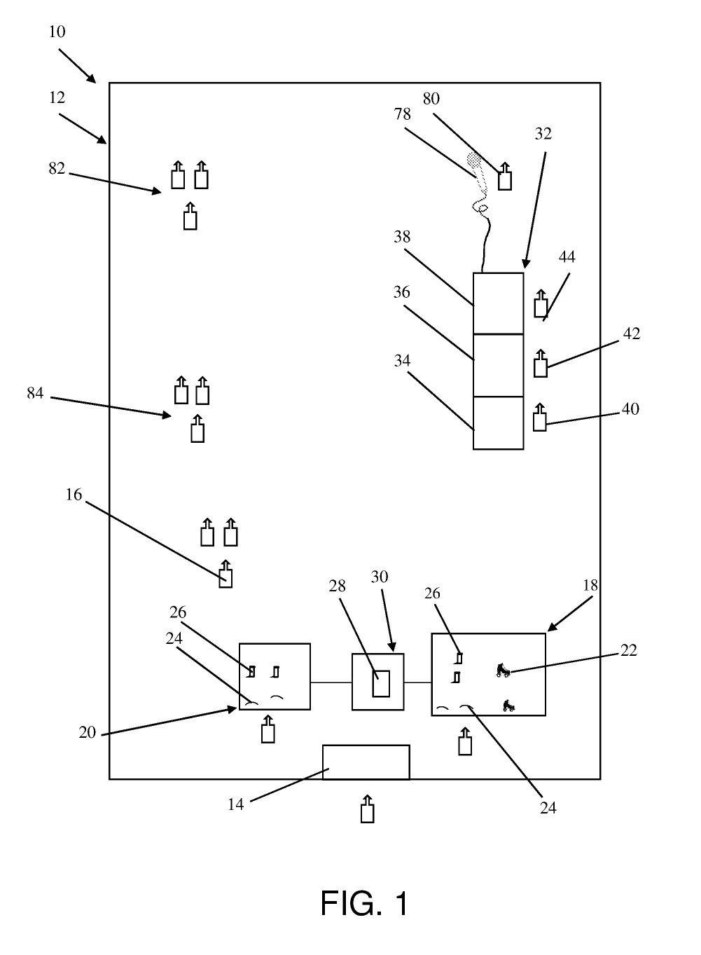

Referring to FIG. 1, a system 10 for hosting a silent skating party is shown. The system includes a roller skating rink 12. The roller skating rink 12 may include an admission station 14 where users 16 pay a fee to enter and use the roller skating rink 12. The roller skating rink 12 includes a skating rental and headphone station 18 and a rental headphone station 20 that does not include rental roller skates 22. The skating rental and headphone station 18 may be a stand that includes rental roller skates 22 and rental wireless headphones 24. The skating rental and headphone station 18 may include waiver forms 26 for the users 16 to sign and include their names and other information before using the rental headphones 24 and rental roller skates 22. The rental headphone station 20 may be a stand that includes only rental wireless headphones 24 for users with roller skates or otherwise do not want to use the rental roller skates 22. The rental headphone station 20 may also include waiver forms 26 for the customers or users of the roller skating rink 12 to sign and include their names and other information before using the rental headphones 24. The customers' names and data on the waiver forms 26 are stored in a database 28 of a computer 30 and may be arranged in alphabetical order. The waiver form 26 makes the user who rents the headphones liable for any loss, damaged or stolen headphones. The stands may be stand-alone or part of the building structure of the roller skating rink 12. Alternatively, the stations 18, 20 may be included in one stand or structure rather than two separate stands or structures.

The roller skating rink system 10 further includes a music station 32 for playing music through speakers within the roller skating rink 12 or through the headphones 24. The music station 32 may have first, second, and third substations 34, 36, 38 for playing different types of music. Each headphone 24 is wirelessly connected to the substations. Each substation may have a disc jockey (DJ) play a certain type of music. For example, the first disc jockey 40 for the first substation 34 may play reggae music. The second disc jockey 42 for the second substation 36 may play disco music. The third disc jockey 44 for the third substation 38 may play country music. The type of music may alternatively be any other type or arrangement such as classical, rock and roll or songs from an album or from various artists.

The disc jockeys may use audio equipment that can play at least two sources of recorded music simultaneously and mix them together to create seamless transitions between recordings and develop unique mixes of songs. Often, this involves aligning the beats of the music sources so their rhythms do not clash when played together or to enable a smooth transition from one song to another. The disc jockeys may use specialized DJ mixers, small audio mixers with crossfader and cue functions to blend or transition from one song to another. Mixers may be also used to pre-listen to sources of recorded music in headphones and adjust upcoming tracks to mix with currently playing music. Disc jockey software may be used with a DJ controller device to mix audio files on a computer instead of a console mixer. Disc jockeys may also use a microphone to speak to the audience either through the headphones or through stand-alone speakers in the roller skating rink. The disc jockey may also use effects units such as reverb to create sound effects and electronic musical instruments such as drum machines and synthesizers.

Each substation may have more types of equipment for the disc jockey to play and mix music. For example, a substation may have two turntables plugged into a DJ mixer for the disc jockey to mix music on vinyl records. The substation may have compact discs that may be played on specialized high quality CD players known as CDJs. CDJs can take the place of turntables or be used together with turntables. The CDJs may play digital music files from USB flash drives or SD cards in addition to CDs. With the use of a portable laptop, tablet, and smartphone computers, the disc jockey may use software together with specialized sound cards and a DJ controller hardware. DJ software can be used in conjunction with a hardware DJ mixer or be used instead of a hardware mixer. The disc jockeys may also have DJ headphones that have properties useful for DJs, such as designs that acoustically isolate the sounds of the headphones from the outside environment (hard shell headphones), flexible headbands

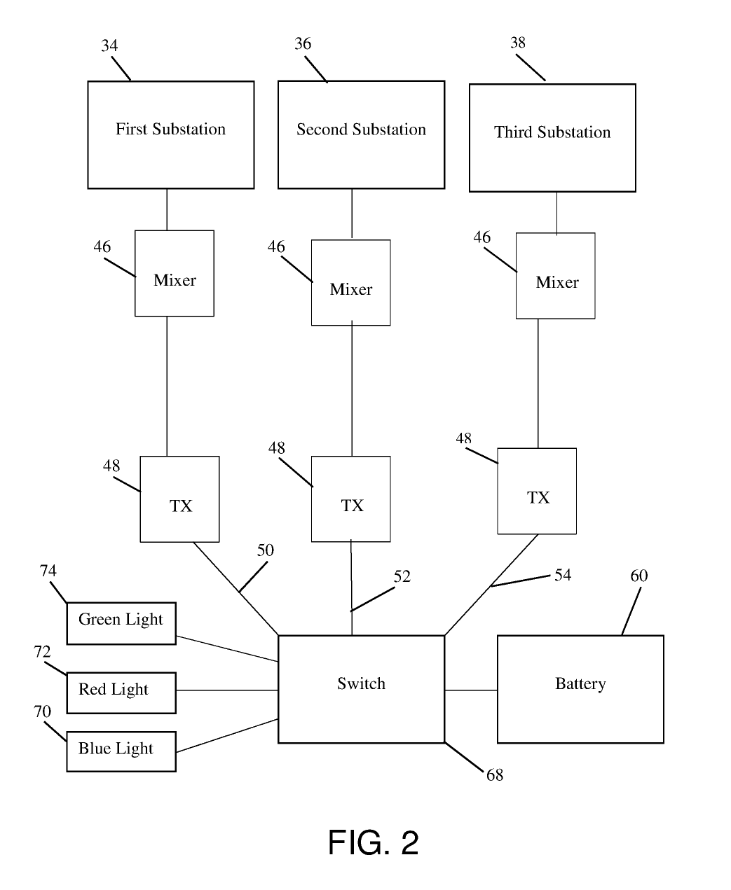

As seen in FIG. 2, a mixer 46 and transmitter 48 may be associated with each substation. The output of the mixer 46 is connected to the transmitter 48 and assigned to one of three channels 50, 52, 54 to enable the substation to transmit the music to the associated channel of the headphone as seen in FIG. 2. For example, the first substation 34 may transmit a first type of music to the first channel 50 of each headphone 24. The second substation 36 may transmit a second type of music to the second channel 52 of each headphone 24, and the third substation 38 may transmit a third type of music to the third channel 54 of each headphone 24.

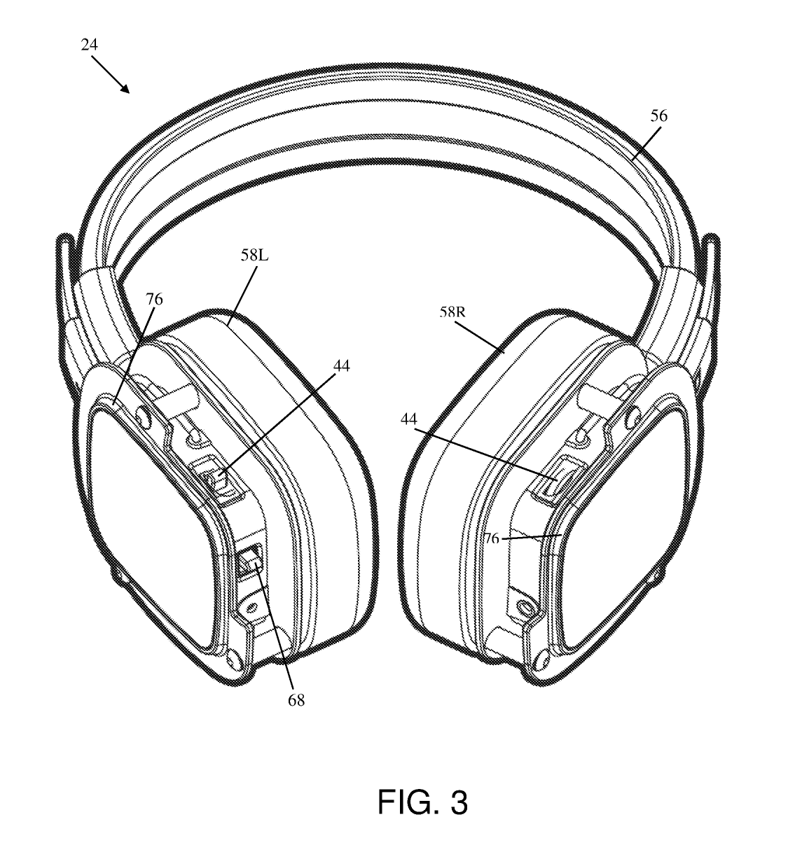

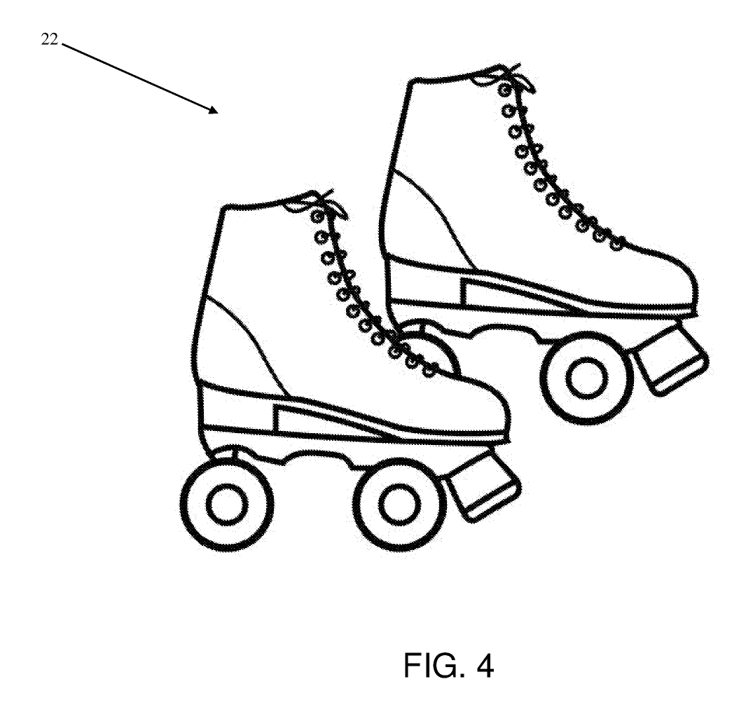

Referring to FIG. 3, each of the headphones 24 given to the users may be a wireless headphone. Each headphone 24 may be configured to be sufficiently sturdy to help prevent it from inadvertently falling off a user's head. Each headphone 24 may include an adjustable headband 56 and ear cups 58R, 58L attached to the ends of the headband 56. The ear cups 58R, 58L may be configured to fit over the ears of the user to help isolate the music that outputs from the ear cups from the outside sounds. Each headphone 24 may be powered by a rechargeable battery 60 or other suitable source as schematically illustrated in FIG. 2. Each headphone may include a power button 62 provided on the side of the left ear cup 58L (as view from FIG. 3) to turn on or off the power to the headphone. Each headphone 24 may also include a volume control knob or wheel 64 provided on the right ear cup 58R to control the volume of the audio being output from the ear cups. Each headphone 24 may also include a charger jack 66 to enable charging of the rechargeable battery 60 of the headphone.

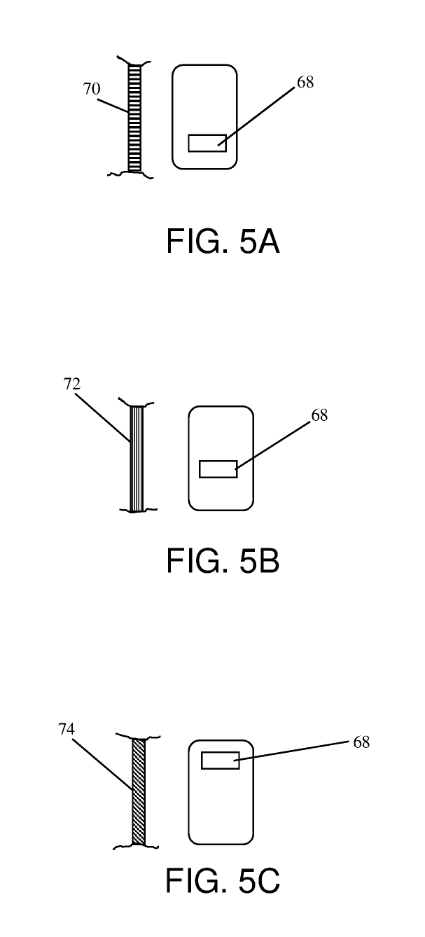

Each headphone 24 may also include a three channel selector switch 68 slidably connected on the side of the left ear cup 58L. The channel selector switch 68 may be slid to first, second, and third positions as shown in FIGS. 5A to 5C. Each position enables the headphone 24 to output or play the type of music that is transmitted through a particular channel. For example, the headphone 24 may output or play the first type of music from the first substation in response to the channel selector switch 68 being in a first position as shown in FIG. 5A. The headphone 24 may output the second type of music from the second substation 36 in response to the channel selector switch 68 being placed in a second position as shown in FIG. 5B. The headphone 24 may output or play the third type of music from the third substation 38 in response to the channel selector switch 68 being placed in a third position as shown in FIG. 5C.

The channel selector switch 68 is operatively associated with light emitting diodes (LED) 70, 72, 74 that illuminate a certain color around the ear cups 58R, 58L when the channel selector switch 68 is in the selected position. For example, as illustrated in FIG. 5A, when the channel selector switch 68 is in a first position, a first LED 70 illuminates a blue color through a tubular bulb 76 around the ear cups 58L, 58R. As illustrated in FIG. 5B, when the channel selector switch 68 is in a second position, a second LED 72 illuminates a red color through the tubular bulb 76 around the ear cups 58R, 58L. As illustrated in FIG. 5C, when the channel selector switch 68 is in a third position, a third LED 74 illuminates a green color through the tubular bulb 76 around the ear cups 58R. 58L.

One example of a wireless headphone that may be used in the systems is a Talent RF-309 Silent Disco 3 Channel Headphone with 3 Color LED. This headphone provides the listener the ability to select between 3 Talent TX-50RF transmitter channels, so that the user can listen to their own type of music personal music selection. The output of the corresponding substation's mixer is connected to the transmitter (via RCA) and assigned to one of the three channels. The headphone provides LED feedback to the DJ and other skaters by illuminating lights on the ear cups with the corresponding color for the corresponding channel (e.g. channel 1: blue, channel 2: red, channel 3: green).

In combination with the Talent TX-50RF transmitters, the Talent RF-309 headphone allows the user to switch between up to 3 channels of transmission. Active noise reduction and the over-the-ear design helps create isolation from environmental noise. An auto mute feature ensures that if no signal is received by the headphone, it will go into a mute mode. The RF-309 headphone features LED illuminated ear cups, volume and channel select controls, and rechargeable batteries charged via included charging cable.

The music station may have a microphone 78 electrically coupled to the music station. The microphone may be used by an announcer 80 that hosts the event. The announcements or other sounds going into the microphone 78 may be transmitted to the rink speakers and also may be received by the transmitter and then transmitted to the headphone 24 regardless of which channel is selected on the headphone in response to the microphone 78 being turn on.

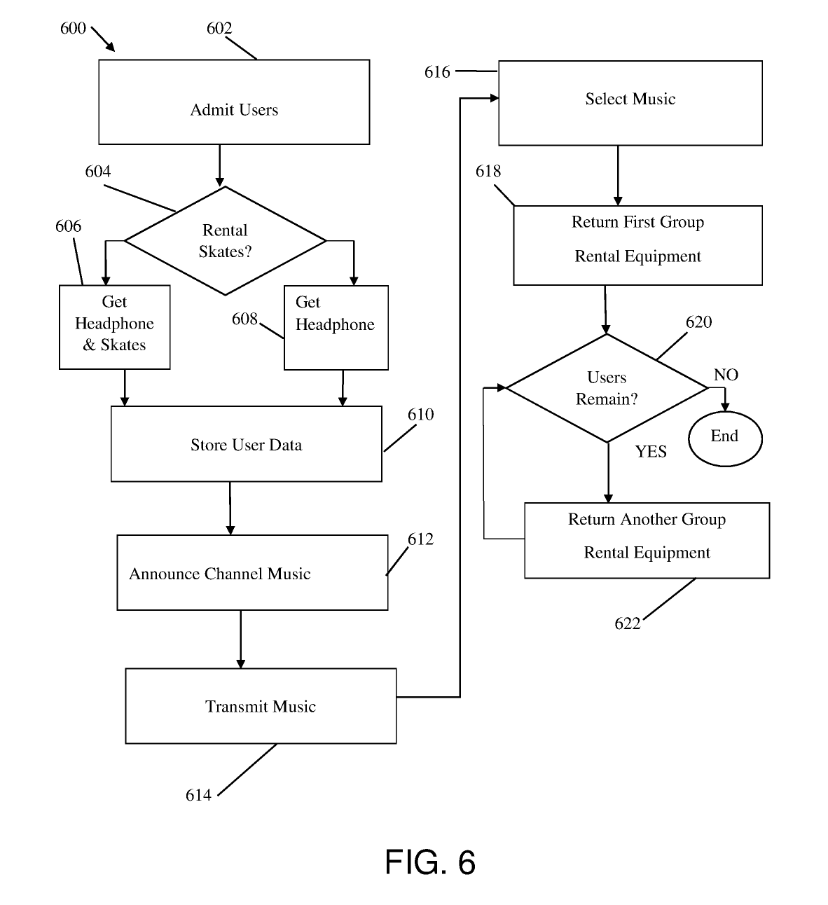

A method 600 of hosting an event at a roller skating rink 12 using the system 10 will now be explained with reference to FIG. 6. In step 602, the customers or users pay the rink fee at the roller skating admission station 14 and are admitted into the roller skating rink 12. In step 604, a query is made as to whether the user wants rental roller skates 22 and headphones 24 or only headphones 24. In step 606, the users who want rental roller skates 22 and headphones 24 go to the rental roller skate and headphone station 22 and obtain their rental roller skates 22 and headphones 24 after showing their identification and filling out and signing the waiver form 26. In step 608, the users who just want rental headphones 24 go to the rental headphone station 20 and obtain their rental headphones 24 after showing their identification and filling out and signing the waiver form 26. In step 610, the users' names and other information on the waiver forms for both stations are stored in the database 28 of the computer 30. Once everyone for a particular event in the roller skating rink 12 has their headphones 24 on, the announcer 80 announces through the microphone 10 which channels correspond to which music in step 612. The announcement may be heard through all channels of the headphone as well as through the speakers in the rink 12. Thus, users who are wearing a headphone 24 with the channel selector switch 68 at any of the positions as well as users or other persons in the roller skating rink 12 who are not wearing a headphone 24 will be able to hear the announcement. In step 614, music of a first type is transmitted from the first substation 34 to the first channel 50 of each headphone 24, music of a second type is transmitted from the second substation 36 to the second channel 52 of each headphone 24, music of a third type is transmitted from the third substation 38 to the third channel 54 of each headphone 24.

In step 616, the users may select the channel for their desired type of music by sliding the channel selector switch 68 to either a first position, second position, or third position. Users then can see which users have which type of music from the colored lights illuminating on the headphones 24 and can form skating groups with the same music type.

If a user wants to talk to another user, the user may either take off their headphone 24 or turn down the music. Since no loud music is being played through the rink speakers, no loud music will interfere with the users' conversation with other persons in the rink, while at the same time the user who wants to listen to music can still do so via the headphone 24.

Periodically, the announcer 80 may interrupt the music outputting from the headphones 24 to give important announcements through the microphone 78. In step 618, once the event is over, the announcer 80 then announces that it is time to return the headphones 24 and rental roller skates 22 and also announce that a first group 82 of users in which the first letter in their last names is between two letters (e.g. A-F) will go return their headphones and (if they rented them) rental roller skates to the station that the users rented them from. In step 620, a query is made as to whether there are remaining user that need to return the rental equipment. If there are remaining users, then after the first group of users returns their headphones and roller skates, the announcer will then announce that another group 84 of users in which the first letter in their last names is between two other letters (e.g. G-M) will go return their headphones and if they rented them, rental roller skates to the station that the users rented them from in step 622. This process repeats until all the users return their rental equipment. This makes the process of returning the headphones and skates more orderly and quicker.

Although various embodiments of the system and method for hosting a silent roller skating event have been shown and described, modifications may occur to those skilled in the art upon reading the specification. The present application includes such modifications and is limited only by the scope of the claims.

What is claimed is:

1. A method of hosting an event at a roller skating rink comprising:
a) admitting users into the roller skating rink at a roller skating admission station;
b) providing roller skates and headphones to users who desire to rent roller skates and headphones at a first station;
c) providing headphones to users at a second station that does not provide roller skates;
d) transmitting music of a first type from a first substation of a music station to a first channel of each headphone;
f) transmitting music of a second type from a second substation of the music station to a second channel of each headphone;
g) transmitting music of a third type from a third substation of the music station to a third channel of each headphone; and
h) enabling the headphone to allow selection of one of the first channel, second channel, and third channel to output music from the selected channel.

2. The method of claim 1, wherein each of the headphones comprises first, second and third lights, wherein the first light illuminates light of a first color when a channel selector switch is in a first position, wherein second light illuminates light of a second color when the channel selector switch is in a second position, wherein the third light illuminates light of a third color when the channel selector switch is in the third position.

3. The method of claim 1, further including interrupting music outputted from the selected channel with audio inputted into a microphone and transmitted from the music station.

4. The method of claim 1, further including providing waiver forms at the first and second substations for users to sign before using the headphones.

5. The method of claim 4, further including storing the names of the users provided on the waiver form by the users in a computer database, interrupting music outputted from the selected channel with audio inputted into a microphone and transmitted from the music station to the headphones.

6. The method of claim 5, further including storing the names of the users provided on the waiver form by the users in a computer database, wherein the audio includes an announcement to the users to return the headphones.

7. The method of claim 6, wherein the announcement includes telling a group of users whose names have a beginning letter that is between two letters of the alphabet.

8. The method of claim 7, further including after interrupting music outputted from the selected channel with audio inputted into a microphone and transmitted from the music station, wherein the audio includes an announcement to the users to return the headphones, providing another announcement through the microphone to tell another group of users whose names have a beginning letter that is between two other letters of the alphabet to return the headphones.

9. A roller skating rink system for hosting an event comprising:
a roller skating rink;
a first station, wherein the first station includes roller skates and a first group of headphones for users to rent;
a second station, wherein the second station includes a second group of headphones for users to rent, wherein the second station does not include roller skates;
a music station, wherein the music station includes first, second, and third substations in operative association with each headphone;
wherein each headphone has first, second, and third channels, wherein each headphone has a channel selector switch, wherein the first substation is configured to transmit a first type of music to the first channel of each headphone, wherein the second substation is configured to transmit a second type of music to the second channel of each headphone, wherein the third substation is configured to transmit a third type of music to the third channel of each headphone; and
wherein each headphone outputs the first type of music from the first substation in response to the channel selector switch being in a first position, wherein each headphone outputs the second type of music from the second substation in response to the channel selector switch being placed in a second position, wherein each headphone outputs the third type of music from the third substation in response to the channel selector switch being placed in a third position.

10. The roller skating rink system of claim 9, further comprising a third station, wherein the third station comprises a rink admission station for admitting the users to the rink.

11. The roller skating rink system of claim 9, wherein each of the first and second stations includes a waiver forms for the users to sign before using the rental headphones.

12. The roller skating rink system of claim 9, wherein each of the headphones comprises first, second and third lights, wherein the first light illuminates light of a first color when the channel selector switch is in the first position, wherein second light illuminates light of a second color when the channel selector switch is in the second position, wherein the third light illuminates light of a third color when the channel selector switch is in the third position.

13. The roller skating rink system of claim 9, further comprising a microphone operatively associated with the music station, wherein the roller rink system is configured to enable audio inputted into the microphone to be outputted from each headphone in response to the microphone being turned on.

14. The roller skating rink system of claim 9, wherein each of the headphones is wireless.
